(19) United States
(12) Patent Application Publication
(10) Pub. No.: US 2010/0108709 A1
(43) Pub. Date: May 6, 2010

(54) Cartridge delivery system utilizing film bags

(75) Inventor: Charles M. Frey, Bozrah, CT (US)

Correspondence Address: PEPE & HAZARD, LLP, 225 ASYLUM ST., HARTFORD, CT, 06103, US

(73) Assignee: Plas-Pak Industries

(21) Appl. No.: 12/378,312

(22) Filed: Feb. 13, 2009

Related U.S. Application Data
(63) Continuation-in-part of application No. 11/027,552, filed on Dec. 30, 2004, now abandoned.

(51) Int. Cl. B65D 35/22; B29C 45/40

(52) U.S. Cl. 222/1; 222/94; 264/334; 222/105

(57) ABSTRACT

A film pack cartridge includes an integrally molded synthetic resin face plate having a discharge opening therein and a nosepiece on one face extending about the opening, and a flexible synthetic resin bag has one end sealingly adhered to the other face of the face plate and about the discharge opening and with the other end of the bag being sealed. Two bags may be disposed side-by-side or one bag may be of annular configuration with a bag of circular configuration disposed therewithin. The cartridges are produced by mounting generally tubular synthetic resin bags on mandrels which are inserted into a mold providing a cavity about an end of said mandrels and bags configured to provide a face plate and nosepiece. Molten synthetic resin is injected into the cavity to form a face plate with the ends of the bags sealingly adhered thereto. The face plate has a discharge opening therein and a nosepiece about said opening aligned with the end of said bag. The pack and mandrels are removed from the cavity, the bags removed from the mandrels, and other ends of the bags are sealed. Flowable compositions are injected through the nosepiece and into the bags.

### CROSS REFERENCE TO RELATED APPLICATIONS

The present application is a continuation-in-part of U.S. patent application Ser. No. 11/027,552 filed Dec. 30, 2004.

### BACKGROUND OF THE INVENTION

The present invention relates to cartridge packs for the dispensing of various components and, more particularly, to cartridge packs employing a pair of film bags containing flowable compositions which are to be admixed when ejected from the dispenser.

Various compositions are packaged in tubular cartridges for use in caulking guns and other types of dispensing mechanisms. In some instances, the dispensing mechanisms will take two or more cartridges side-by-side so that the contents of the cartridges are dispensed simultaneously and admixed in a mixer as they flow towards the point of deposition. Typically, such cartridges have employed tubes of plastic, or coated or laminated paperboard, and the like. Moreover, the tubes generally have been filled through one end of the tube after which a closure is placed thereover. Using such side-by-side cartridges to dispense two components involves a substantial amount of waste and expense.

In recent years there has been considerable activity in cartridges comprising film bags within a cylindrical shell. Exemplary of such cartridges are those disclosed in Keller U.S. Pat. No. 5,647,510, and the several embodiments proposed by Konuma et al, U.S. Pat. No. 5,593,066.

Although such cartridges have represented an improvement from the standpoint of ease of use, generally the structures have been relatively complicated to fabricate and relatively costly. Obtaining good seals between the bags and the face piece of the cartridge has been a problem. Filling of the film bags and their handling has often presented a problem in automated equipment.

It is an object of the present invention to provide a novel film pack cartridge for dispensing components which is relatively simple to fabricate easy to fill and relatively trouble free during the dispensing operation.

It is also an object to provide such a dispenser cartridge which is relatively economical to fabricate and which permits dispensing of the contents at several different times.

Another object is to provide such a dispenser cartridge which is readily adapted to different ratios of the components.

A further object is to provide a dispenser cartridge which can be filled after assembly of the bags and the face plate.

A still further object is to provide a preferred method and mold for securing the face plate to the film bag.

### SUMMARY OF THE INVENTION

It has now been found that the foregoing and related objects may be readily attained in a film pack cartridge including an integrally molded synthetic resin face plate having a discharge opening and a nosepiece on one face extending about the opening. At least one flexible synthetic resin bag has one end sealingly adhered to the other face of the face plate about the discharge opening, and the other ends of the bags are sealed.

Preferably, the face plate has a flange on the other face which extends about the opening, and one end of each of the bags is sealingly adhered to the flange. The bags and the face plate are preferably fabricated from substantially the same synthetic resin to obtain a good bond.

The face plate is over molded on the film bag to produce an integrated structure of essentially uniform composition in which the bag is disposed inwardly of the face plate and there are no distinct layers in the interface.

In one embodiment, a pair of tubular bags each have one end adhered to the face plate in side-by-side registry with a portion of the discharge opening, and the discharge opening has a divider extending therein so that the contents of the bags remain separated as they pass through the opening. The nosepiece has a partition therein aligned with the divider in the opening to maintain separation of contents passing thereinto.

In another embodiment, the opening has a generally circular periphery and the face plate includes a generally circular divider supported within the opening to provide a generally annular peripheral portion of the opening and a generally circular portion spaced centrally thereof. One of the bags is of annular configuration and has the one end sealingly adhered to the face plate about the peripheral portion of the discharge opening, and the other of the bags has a circular cross section and is disposed in the center of the annular bag and in sealing engagement with the circular divider. The face plate has a nosepiece thereon extending from the discharge opening and a circular partition corresponding to the divider to maintain separation of the contents passing thereinto.

The cartridges are filled with flowable compositions and will normally have a sealing cap on the end of the nosepiece which is replaced by a static mixer when discharging the contents.

In use, the filled film bag cartridge is mounted in a dispenser including a housing with a dispensing end, a tubular sleeve, and a piston is movable in the sleeve towards the dispenser end. The film pack which is disposed in the tubular sleeve can be removed so that the sleeve can be reused.

In the preferred method for producing dispenser packs of flowable compositions, a generally tubular flexible synthetic resin bag is supported on a mandrel, and the mandrel and bag are inserted into a mold providing a cavity about the end of the mandrel and bag; the cavity is configured to provide the face plate and nosepiece. Molten synthetic resin of substantially the same composition as that of the bag is injected into the cavity to form a face plate with the end of the bag sealingly adhered to the inner face thereof. The face plate has a discharge opening therein and a nosepiece about the opening is aligned with the end of the bag. The face plate, bag and mandrel are received from the cavity, the bag and face plate are removed from the mandrel, and the end of the bag spaced from the face plate is sealed. A flowable composition is injected through the nosepiece and opening in the face plate and into the bag, and a sealing cap is mounted on the nosepiece.

In one embodiment, a pair of synthetic resin bags are mounted on a pair of mandrels which are cooperatively configured and cooperate to define a generally circular cross section when placed in a cylindrical sleeve. The mold cavity and mandrels are configured to provide a partition in the opening in the face place and a nosepiece separating the contents of the two bags as the compositions in the bags flow therethrough. Flowable compositions are injected into each of the bags through the nosepiece.

In another embodiment, a pair of synthetic resin bags are mounted on a pair of mandrels, one of which is annular cross section and the other is of circular cross section and disposed within the annular mandrel. The mold cavity is configured to provide a face plate with a partition in the opening and nosepiece separating the contents of the two bags as the composition in the bags flow therethrough.

### BRIEF DESCRIPTION OF THE DRAWINGS

FIG. 1 is a longitudinal view in partial section of a cartridge dispenser in which there is seated a film pack cartridge embodying the present invention;

FIG. 2 is a sectional view the film pack cartridge and dispenser along the line 2-2 of FIG. 1;

FIG. 3 is a longitudinal sectional view of the cartridge of FIG. 1;

FIG. 4 is a side elevational view of the face plate;

FIG. 4a is a rear view of the face plate of the cartridge shown in FIGS. 2 and 3;

FIG. 5 is a front view of the face plate of the cartridge shown in FIGS. 2 and 3;

FIG. 6 is a longitudinal sectional view of an alternate embodiment of the cartridge of the present invention;

FIG. 7 is a front view of the face plate of FIG. 6;

FIG. 8 is a rear view thereof;

FIG. 9 is a diagrammatic view of film bags mounted on coaxial mandrels and disposed within a mold to form the face plate;

FIG. 10 is a view similar to FIG. 9 for making a cartridge with side-by-side bags;

FIG. 11 is a diagrammatic view of the film bag/face plate assembly with a dispenser tube coupled to the face plate for introduction of the flowable composition into one of the bags;

FIGS. 12a and 12b are respectively side and rear elevational views of a cap;

FIGS. 13a and 13b are respectively side and front views of a coupler;

FIG. 14 is a longitudinal view of a static mixer;

FIG. 15 is a diagrammatic illustration of the mold cavity film and overmolded face plate;

FIG. 16 is a photograph of a dual film bag of the present invention prior to filling and sealing of the lower end;

FIG. 17 is a photograph of a fragmentary single bag of the present invention;

FIG. 18 is a photograph of a single bag from what is understood to be a licensee of Konuma and made in accordance with U.S. Pat. No. 5,593,066; and

FIG. 19 is a photograph of an enlarged fragmentary film bag with a base closure member engaged with the lower end of the tubular film bag.

### DETAILED DESCRIPTION OF THE ILLUSTRATED EMBODIMENT

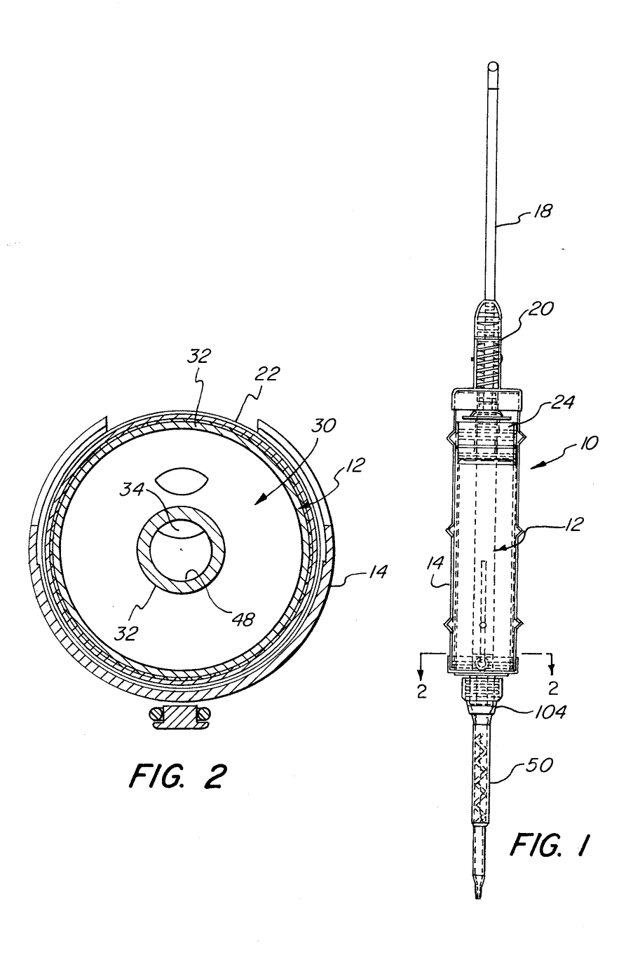

Turning first to FIG. 1, therein illustrated a conventional caulking gun generally designated by the numeral 10 in which is seated a filled film bag cartridge embodying the present invention and generally designated by the numeral 12. The caulking gun 10 has an arcuate housing 14, an end plate 16, a piston/rod 18 and an actuator assembly 20. Disposed in the housing 14 is the cartridge 12 which is supported in the cylindrical sleeve 22, and a cylindrical shuttle 24 which is moved in the sleeve 22 against the cartridge 12 by the piston/rod 18.

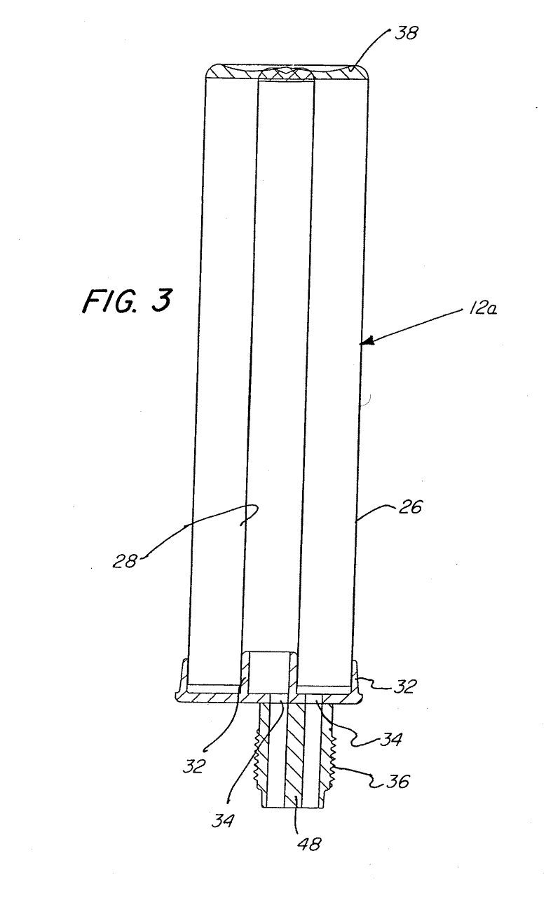

Turning next to FIGS. 2-5, therein illustrated is a film bag cartridge 12a embodying the present invention in which there is an outer annular bag 26, an inner cylindrical bag 28 and a face plate generally designated by the numeral 30 to which one end of the bags 26,28 are adhered. The face plate 30 has rearwardly projecting flanges 32 which provide the surface to which the bags 26,28 are adhered, and a discharge opening generally designated by the numeral 34. Extending about the discharge opening 34 and extending forwardly is a nosepiece generally designated by the numeral 36. The opposite ends of the bags 26,28 are sealed as indicated by the cross hatching 38.

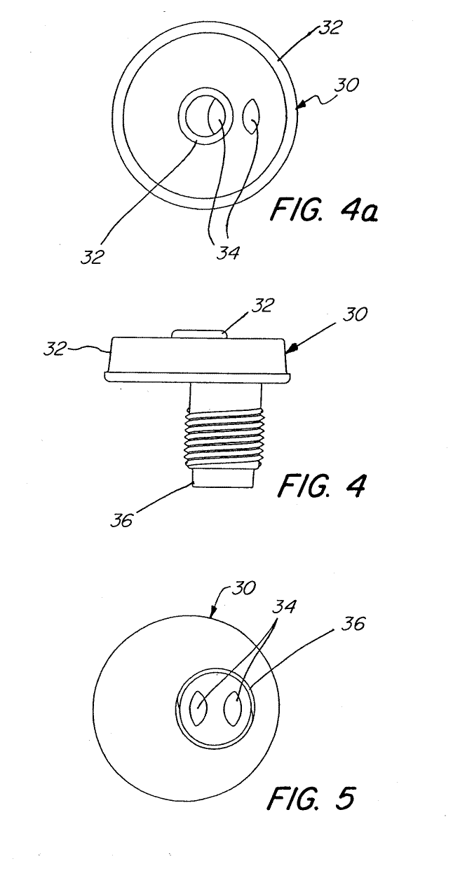

As seen in FIGS. 4 and 5, the discharge opening 34 in the face plate 30 allows the contents of the bag 26 to flow through the portion 40, and the contents of the bag 28 flow through the portion 42.

The passage through the nosepiece 36 has a partition 48 which maintains the separation of the two streams until they enter the static mixer generally designated by the numeral 50 and which is secured onto the nosepiece 36.

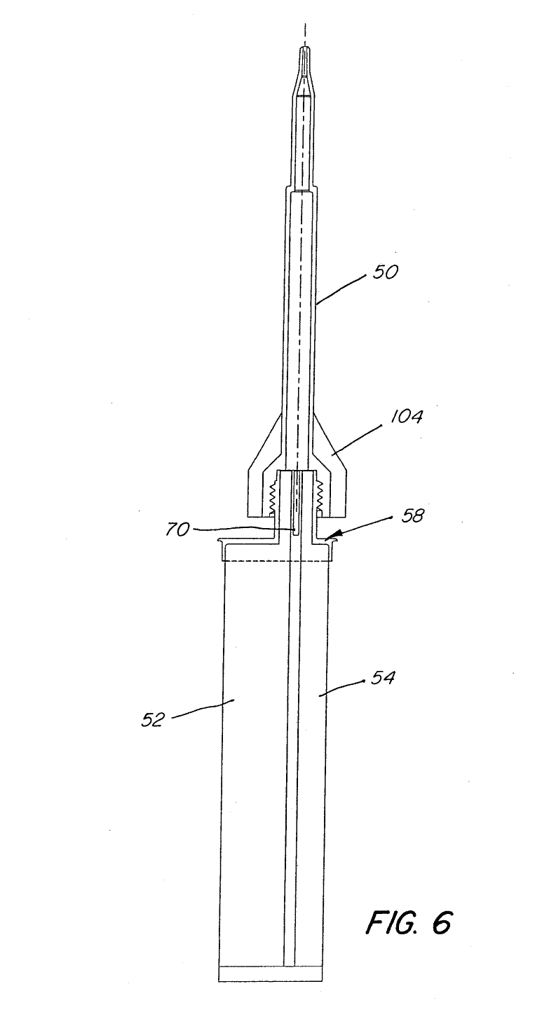

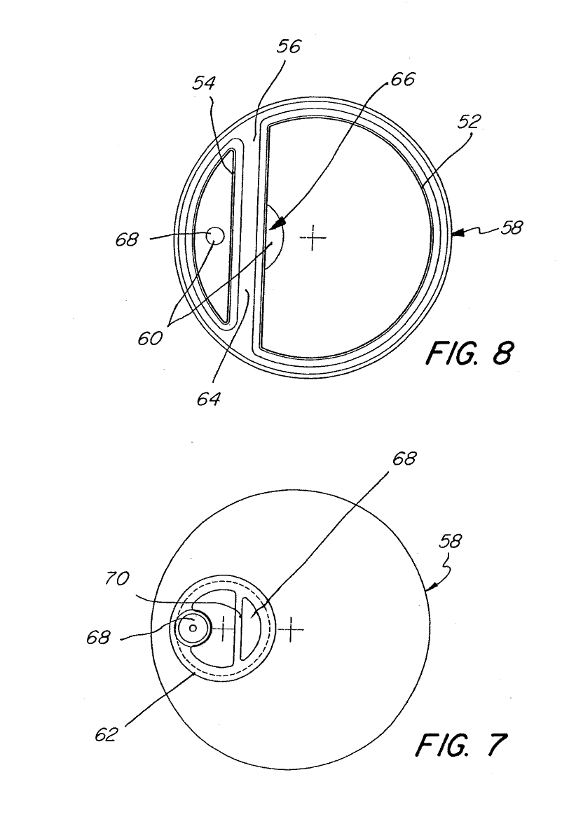

Turning next to FIGS. 6-8, this cartridge embodiment 12b of the present invention has a pair of generally cylindrical bags 52,54 of different cross sectional area (about 3:1). One end is adhered to the flanges 56 of the face plate generally designated by the numeral 58. As in the first embodiment, there is a discharge opening generally designated by the numeral 60 and a nosepiece 62 which extends thereabout. The opening 60 has a partition 64 so that the contents of the bag 52 flow through the portion 66 and the contents of the bag 54 flow through the portion 68. The nosepiece 62 has a cooperating and aligned partition 70, and the opposite ends of the bags are sealed as indicated by the numeral 72.

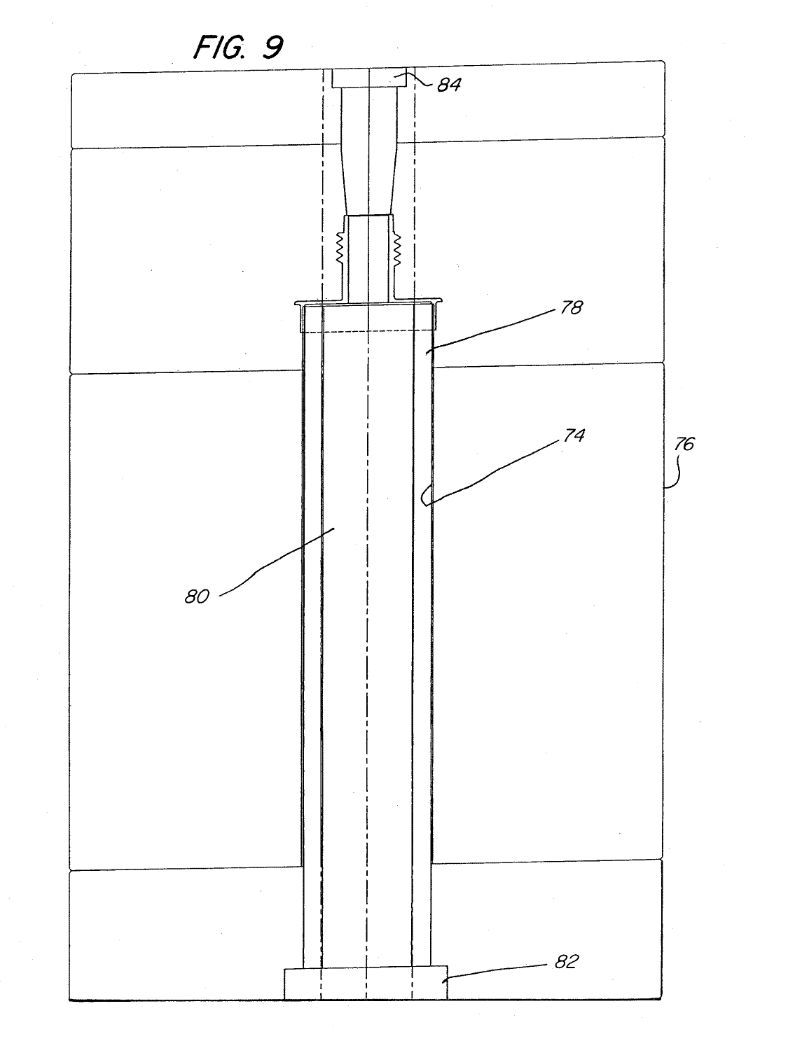

Turning next to FIG. 9, therein schematically illustrated is the mold assembly for integrally molding the face plate 30 about the ends of the coaxial bags 26,28 and bonding the components in assembly. Seated in a complimentary cavity 74 in a mold 76 are an annular mandrel 78 and a coaxial cylindrical mandrel 80 upon which are slidably supported the annular bag 26 and the cylindrical bag 28. The mandrels 78,80 are supported on the base 82, and a secondary core 84 extends downwardly to cooperate with the mandrels 78,80 to provide a cavity portion 86 corresponding to the configuration desired for the face plate 30.

Molten synthetic resin is injected into the cavity portion 86 through runners (not shown) to produce the desired face plate 30 including the flanges 32, discharge opening 34 and nosepiece 36. The molten resin heats the exposed end portions of the bags 26,28 to effect a strong bond between the bags 26,28 and face plate 30. After cooling, the mold 76 is opened and the mandrel fixture is withdrawn. The film bags 26,28 are slid off the mandrels 78,80 and the opposite ends of the bags are sealed to provide an empty cartridge.

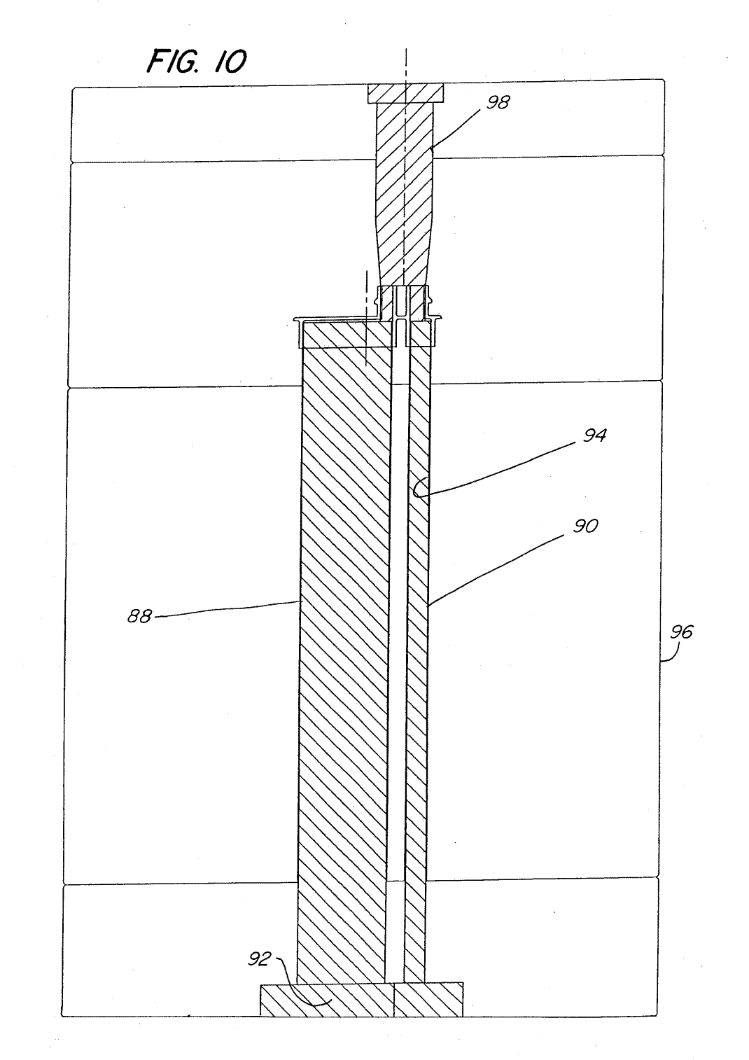

Turning next to FIG. 10, therein illustrated is the mold assembly for molding and bonding the bags 52,54 to the face plate 58 for the embodiment of FIGS. 6-8. A large diameter mandrel 88 and a small diameter mandrel 90 are supported on the base 92 and have the bags 52,54 supported thereon in the cavity 94 of the mold 96. The secondary core 98 cooperates with the mold cavity 94 to provide a cavity portion in which the ends of the bags 52,54 are exposed so that resin will flow thereabout to form the face plate 58 and bond the components. After cooling, the mandrel assembly is withdrawn from the mold 96 and the face plate and bags are removed therefrom to provide the empty cartridge.

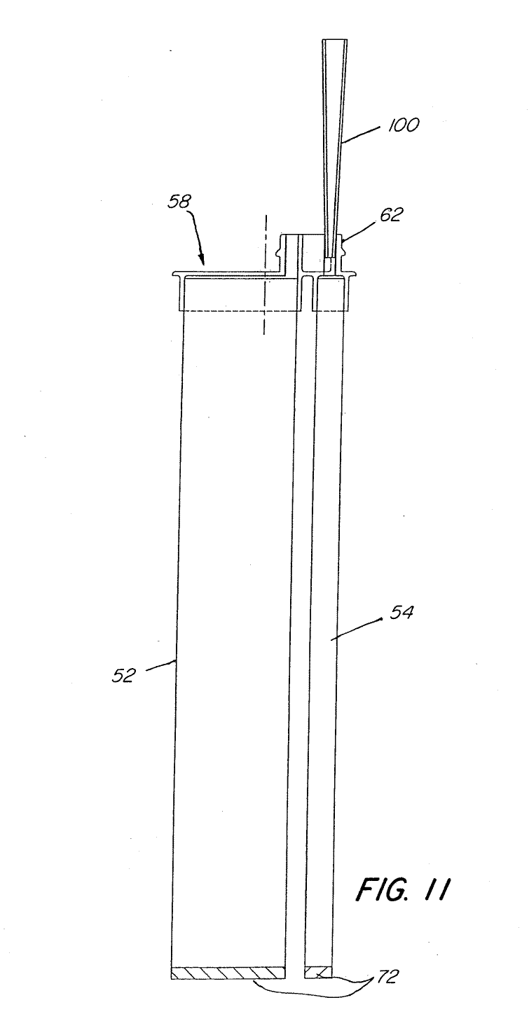

Turning next to FIG. 11, an empty cartridge 12a is supported on a fixture (not shown), and air is evacuated from the bags 52,54. A first flowable composition is injected into the small bag 54 through the fill tube 100 which is seated in the face plate 58. Generally, the flowable composition will extend into the nosepiece 62. After the bag 54 is filled, a similar fill tube (not shown) is inserted into the nosepiece 62 and a flowable composition is injected into the large bag 52.

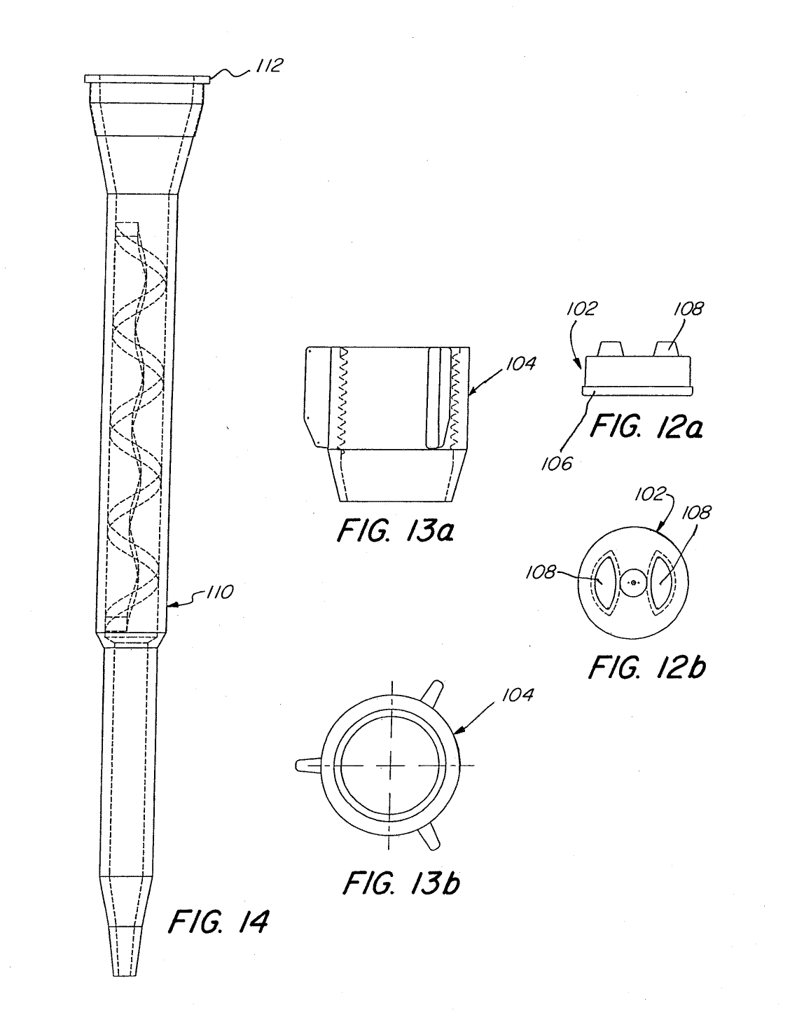

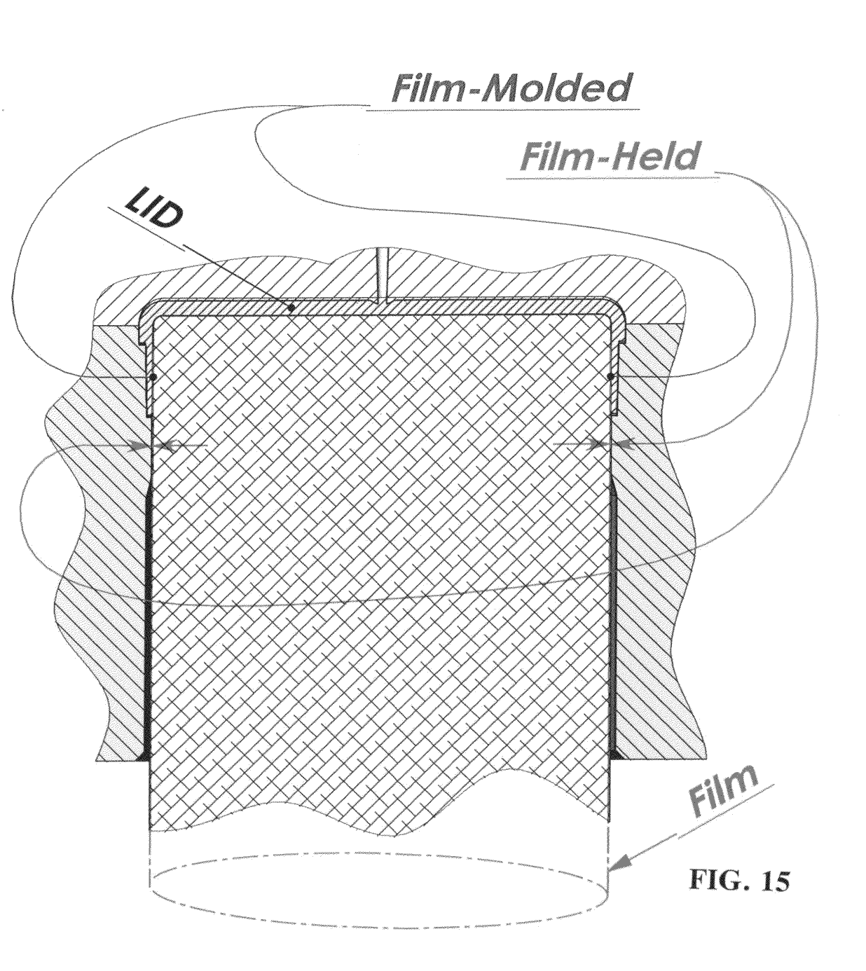

Turning now to FIGS. 12a and 12b, and FIGS. 13a and 13b, after the bags have been filled, the cap generally designated by the numeral 102 is secured to the nosepiece 62 by the internally threaded coupler generally designated by the numeral 104 which bears against a flange 106 on the cap 102 and threads onto the nosepiece 62. The cap 102 has portions 108 which extend into the nosepiece 62.

The coupler 104 also serves to mount the static mixer generally designated by the numeral 110 since the coupler 104 bears against the flange 112 of the mixer 110.

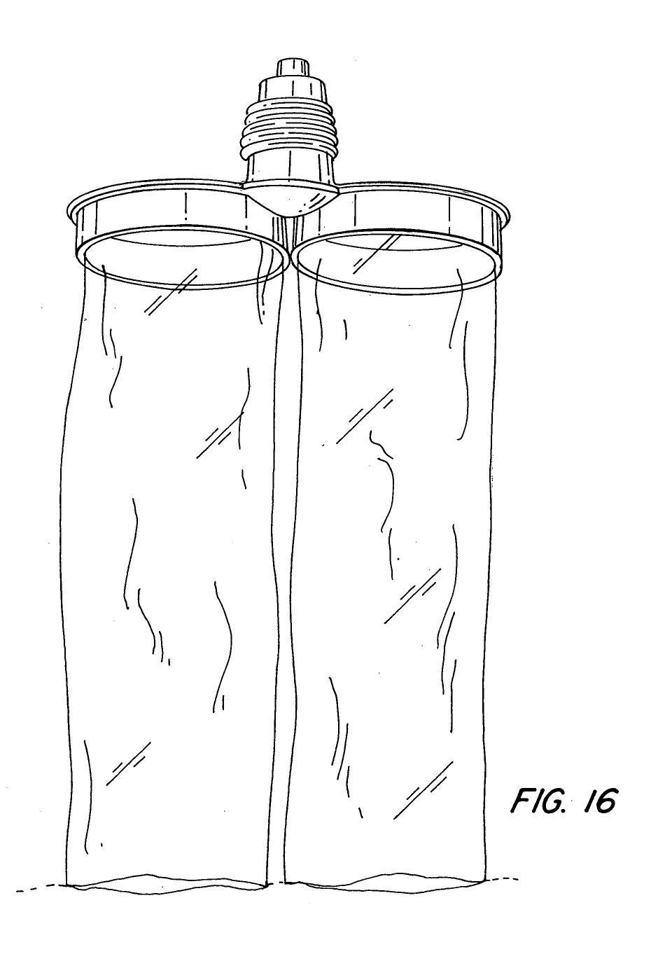

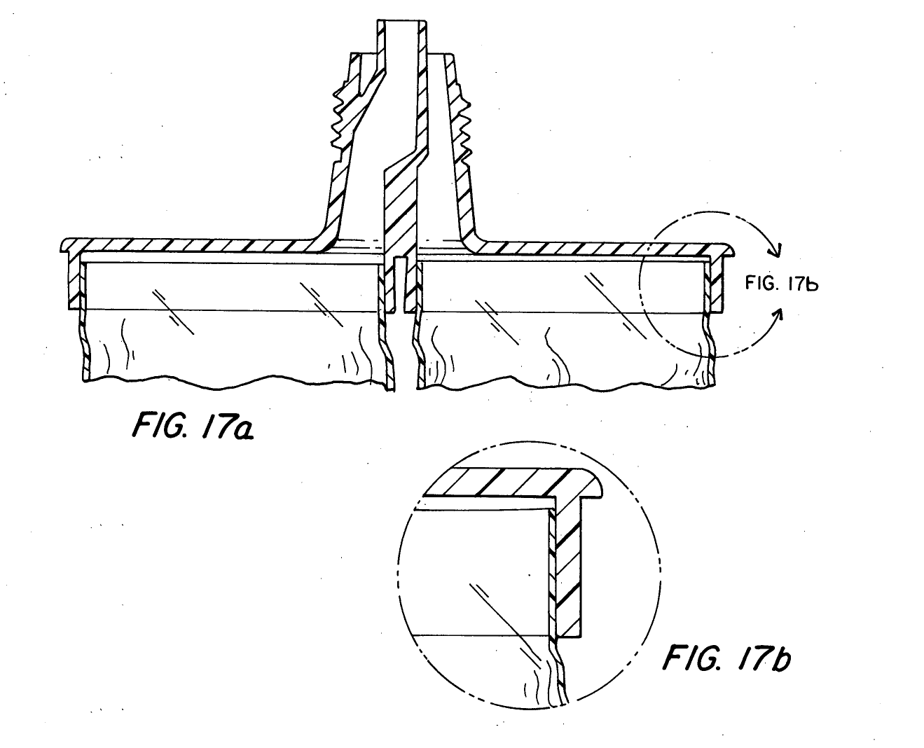

FIG. 16 is a photograph of a dual film pack cartridge sold commercially by Applicant's assignee. The film packs are side by side and the face plate is disposed about the end of the tubular film bags.

FIG. 17a is a photograph of a dual bag and face plate.

FIG. 17b is a photograph of an enlarged fragmentary portion thereof.

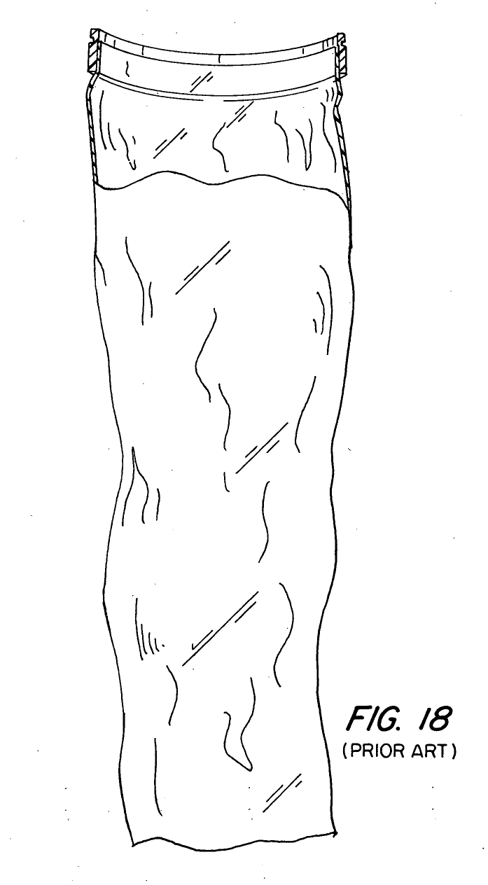

FIG. 18 is a photograph of a single film bag cartridge made in accordance with the Konuma et al patent.

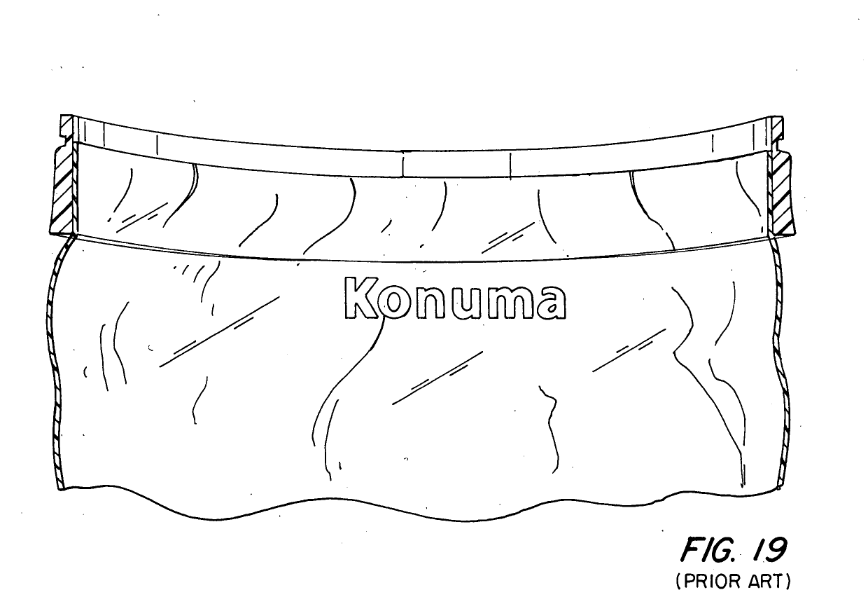

FIG. 19 is an enlarged fragmentary view of the Konuma bag reinforcing member assembly. The film bag is placed about the periphery of the reinforcing member and is adhered to the outer surface of the reinforcing member.

By supporting the upper ends of the mandrel in a properly configured mold cavity, the molten resin will flow about the upper end of the film bag and cause it to become molten and intermix with the molten resin flowing into the cavity

As used herein, the term “discharge” opening includes single partitioned openings and spaced, separate openings. The configuration and size will vary with the volume to flow therethrough and the bag configuration.

As used herein, the term “synthetic resin” includes homopolymers and interpolymers, and various additives including fillers, reinforcing elements, etc. In the instance of the film bags, it includes not only homogenous films but also laminates of different resins with and without additives. A preferred resin is polypropylene but polyethylene and nylon may also be used. For some applications, it is desirable to use a composite film with a center layer of nylon and inner and outer layers of polypropylene.

As used herein, the term “substantially identical” composition refers to resins of similar chemistry which will bond strongly. In the instance of laminates, the resin layer providing the surface of the bag to be bonded to the face plate should be substantially identical to that the resin of the face plate so that the bag will firmly bond thereto.

The film bags are generally formed from tubular film cut to the desired length. Although blown film is preferable, flat film may be formed into a tube with bonded overlapping edges.

Bonding of the ends of the bags remote to the face plate can be effected by adhesives, heat, sonic welding, and other readily available techniques.

Applicant's process of overmolding the face plate on the exterior of the film eliminates secondary operations with premolded members.

It can be seen that the present process permits use of bags of laminated films including one or more resins providing desired properties such as resistance to attack by the contents better bonding and mixing of the resins of the film and face plates.

In contrast, microscopic analysis of the film/reinforcing member of Konuma shows multiple defined layers whereas the overmolding of the present invention produces an integrated structure of essentially uniform composition in which the bag is disposed inwardly of the face plate and there are no distinct layers at the interface.

Various flowable compositions may be used in the film packs including sealants, adhesives, protectants, paints and other coating materials, foams, etc. The film exposed thereto and the face plate should have a composition which will not be adversely affected thereby.

The mixed components exiting the static mixer can be applied directly or sprayed by use of a pressurized air source and a suitable nosepiece assembly.

The dimensioning (cross sectional area) of the bags in a film pack will allow proportionating the two components to be mixed. For a 1:1 ratio, the bags have the same cross sectional area. For a 3:1 ratio, one of the bags will have a cross sectional area which is three times that of the other. When the relative viscosity of the compositions or the ratios warrants, the discharge openings may also be customized to facilitate or retard flow therethrough.

The discharge opening may assume several different configurations but should provide partitioning of the flowable compositions until after they have passed into the nosepiece. Moreover, the configuration and dimensioning of the separate portions may provide a restriction for one of the flowable compositions to accommodate variation in viscosity, different ratios, etc.

The bags are filled by injecting the flowable compositions through the discharge opening(s). After sealing the opposite end of the bags, the face plate can be mounted on a fixture which allows the bags to extend vertically downwardly. A vacuum may be drawn on the bags through the nosepiece to facilitate the filling of the bags without having to vent air from the bags as they are being filled, or a nitrogen purge may be used. Alternatively, the bags may have a porous vent to permit air to pass therethrough but not the composition being introduced into the bag.

The dispensers conveniently use as sleeves cylindrical tubes of synthetic resin, spiral wound paperboard, metal and laminates which can be reused. By use of shuttles acted on by the pusher of the piston, the shuttles are moved in the sleeve against the bags to compress them. When the film packs are only partially discharged, the static mixer can be removed and discarded, and the cap is placed on the nosepiece. If the contents are fully discharged, the static mixer is removed and the film pack can be removed from the sleeve; both are discarded. A new film pack can be placed in the sleeve which is rotated end for end before placement in the dispenser. Thus, the shuttle is at the opposite end of the dispenser to be acted upon by the pusher of the piston when the sleeve and cartridge are placed in the dispenser.

Thus, the discharged film pack cartridges and static mixers are discarded, but the dispensers, sleeves and shuttles are all reusable.

Thus, it can be seen from the foregoing detailed description and attached drawings that the film bag cartridges of the present invention are relatively simple to fabricate and the components are bonded to provide good sealing. The bags can be filled easily after assembly of the components.

Having thus described the invention, what is claimed is:

1. A film pack cartridge comprising:
(a) an integrally molded synthetic resin face plate having a discharge opening therein and a nozzle on one face extending about said opening, said face plate having a flange on the other face extending about said opening; and
(b) at least one flexible synthetic resin bag having one end sealingly adhered to said flange on said other face of said face plate about said discharge opening, the other end of said bag being sealed, said face place being overmolded on the outer surface of said one end of said bag whereby said bag is sealingly adhered to the inner surface of said flange, said face plate being overmolded on said film to produce an integrated structure of essentially uniform composition in which said bag is disposed inwardly of said face plate and there are no distinct layers at the interface.

2. The film pack cartridge in accordance with claim 1 wherein said face plate has a flange on said other face and extending about said opening, and said one end of said bag is sealingly adhered to said flange.

3. The film pack cartridge in accordance with claim 1 wherein the abutting surfaces of said bag and said face plate are fabricated from substantially the same synthetic resin.

4. The film pack cartridge in accordance with claim 1 wherein there are a pair of tubular bags each have one end adhered to said face plate in side-by-side registry with a portion of said discharge opening and wherein said discharge opening has a divider extending therein so that the contents of the bags remain separated as they pass through said opening.

5. The film pack cartridge in accordance with claim 4 wherein said nozzle has a partition therein aligned with the divider in said opening to maintain separation of contents passing thereinto.

6. The film pack cartridge in accordance with claim 4 wherein said opening has a generally circular periphery and said face plate flange provides a generally circular divider supported within said opening to provide a generally annular peripheral portion of said opening and a generally circular portion spaced centrally thereof, one of said bags being of annular configuration and having the outer surface said one end sealingly adhered to the inner surface of said flange about said peripheral portion of said discharge opening, and the other of said bags having a circular cross section and having its outer surface disposed in the center of said annular bag and in sealing engagement with the inner surface of said circular divider.

7. The film pack cartridge in accordance with claim 6 wherein the face plate has a nozzle thereon extending from said discharge opening and including a circular partition corresponding to said circular divider to maintain separation of the contents passing thereinto.

8. The film pack cartridge in accordance with claim 4 including a sealing cap on the end of said nosepiece.

9. The film pack cartridge in accordance with claim 1 including a static mixer mounted on the end of said nozzle.

10. The film pack cartridge in accordance with claim 1 wherein there is included a flowable composition in said bag.

11. A cartridge dispenser assembly including:
(a) a dispenser including a housing with a dispensing end, a tubular sleeve, and a piston movable in said sleeve towards said dispenser end;
(b) a film pack disposed in said tubular sleeve and including (i) an integrally molded synthetic resin face plate having a discharge opening therein and a nozzle on one face extending about said opening, said face plate having a flange on the other face and extending about said opening, and (ii) a pair of flexible synthetic resin bags each having one end sealingly adhered to said flange on the other face of said face plate about said discharge opening, the other ends of said bag being sealed, said face plate being overmolded on the outer surface of said one end of each of said bags to produce an integrated structure of substantially uniform composition free from distinct layers at the interface whereby said bags are sealingly adhered to the inner surface of said flange nozzle extending outwardly of said dispensing end of said dispenser.

12. The cartridge dispensing assembly in accordance with claim 11 wherein said bags and said face plate are fabricated from substantially the same synthetic resin.

13. The cartridge dispensing assembly in accordance with claim 11 wherein there are included flowable compositions in said bags.

14. The cartridge dispensing assembly in accordance with claim 11 wherein said pair of tubular bags each have one end secured to said face plate in side-by-side registry with a portion of said discharge opening and wherein said discharge opening has a divider extending therein so that the contents of the bags remain separated as they pass through said opening, and wherein said nosepiece has a partition therein aligned with the divider in said opening to maintain separation of contents passing thereinto.

15. The cartridge dispensing assembly in accordance with claim 11 wherein said opening has a generally circular periphery and said face plate flange provides a generally circular divider supported within said opening to provide a generally annular peripheral portion of said opening and a generally circular portion spaced centrally thereof, and wherein one of said bags is of annular configuration and has the outer surface of said one end sealingly adhered to the inner surface of said flange about said peripheral portion of said discharge opening, and wherein the other of said bags has a circular cross section and with its outer surface disposed in the center of said annular bag in sealingly engagement with the inner surface of said circular divider, and wherein the face plate has a nozzle thereon extending from said discharge opening and including a circular partition corresponding to said circular divider to maintain separation of the contents passing thereinto.

16. The cartridge dispensing assembly in accordance with claim 11 including a sealing cap on the end of said nozzle, and wherein there are included flowable compositions in said bags.

17. In a method for producing dispenser packs of flowable compositions, the steps comprising:
(a) mounting a generally tubular flexible synthetic resin bag on a mandrel;
(b) inserting said mandrel and bag into a mold providing a cavity about an end of said mandrel and bag, said cavity being configured to provide a face plate and nosepiece;
(c) injecting into said cavity molten synthetic resin of substantially the same composition as that of said bag to form a face plate with the end of the bag sealingly adhered thereto, said face plate having a discharge opening therein and a nosepiece about said opening aligned with the end of said bag, said face plate being overmolded on said film to produce an integrated structure of essentially uniform composition in which said bag is disposed inwardly of said face plate and there are no distinct layers at the interface;
(d) removing said face plate, bag and mandrel from said cavity;
(e) removing said bag and face plate from said mandrel; and
(f) sealing the end of said bag spaced from said face plate.

18. The method in accordance with claim 17 including the further steps of injecting a flowable composition through said nosepiece and opening in said face plate and into said bag, and mounting a sealing cap on said face plate nosepiece.

19. The method in accordance with claim 17 wherein a pair of synthetic resin bags are mounted on a pair of mandrels and wherein the mandrels are cooperatively configured and cooperate to define a generally circular cross section, said mold cavity and mandrels being configured to provide a partition in said opening and a nosepiece separating the contents of the two bags as the compositions in said bags flow therethrough, and wherein flowable compositions are injected into each of said bags through said nosepiece.

20. The method in accordance with claim 17 wherein a pair of synthetic resin bags are mounted on a pair of mandrels, one of which is annular cross section and the other is of circular cross section and disposed within said annular mandrel, said mold cavity being configured to provide a face plate with a partition in said opening and nosepiece separating the contents of the two bags as the composition in said bags flow therethrough, and wherein flowable compositions are injected into each of said bags through said nosepiece.

21. In a method for dispensing flowable compositions, the steps comprising:
(a) forming a film pack cartridge comprising an integrally molded synthetic resin face plate having a discharge opening therein and a nosepiece on one face of said face plate extending about said opening; and a pair of flexible synthetic resin bags each having one end sealingly adhered to the other face of said face plate about said discharge opening, the other end of said bag being sealed, said face plate being overmolded on said film to produce an integrated structure of essentially uniform composition in which said bag is disposed inwardly of said face plate and there are no distinct layers at the interface;
(b) filling said bag by injecting flowable compositions through said nosepiece;
(c) placing a sealing cap on said nosepiece;
(d) placing said cartridge in a tubular sleeve;
(e) removing said cap and coupling a dispensing nozzle to said nosepiece;
(f) moving a piston in said sleeve against said other end of said bag to discharge the contents of said bag through said discharge opening and mixer.

22. The method for dispensing a fluid composition in accordance with claim 21 wherein said face plate has a flange on said other face and extending about said opening, and said one end of each of said bags is sealingly adhered to said flange, and wherein said bags and said face plate are fabricated from substantially the same synthetic resin.

23. The method for dispensing a fluid composition in accordance with claim 21 wherein said pair of tubular bags each have one end adhered to said face plate in side-by-side registry with a portion of said discharge opening and wherein said discharge opening has a divider extending therein so that the contents of the bags remain separated as they pass through said opening, and wherein said nosepiece has a partition therein aligned with the divider in said opening to maintain separation of contents passing thereinto.

24. The method for dispensing a fluid composition in accordance with claim 21 wherein said opening has a generally circular periphery and said face plate includes a generally circular divider supported within said opening to provide a generally annular peripheral portion of said opening and a generally circular portion spaced centrally thereof, and wherein one of said bags is of annular configuration and has said one end sealingly adhered to said face plate about said peripheral portion of said discharge opening, and wherein the other of said bags has a circular cross section and is disposed in the center of said annular bag and in sealingly engagement with said circular divider, and wherein the face plate has a nosepiece thereon extending from said discharge opening and including a circular partition corresponding to said circular divider to maintain separation of the contents passing thereinto.

25. In a method for producing a dispenser pack for a flowable composition, the steps comprising:
(a) mounting a generally tubular flexible synthetic resin bag on a mandrel;
(b) inserting said mandrel and bag into a mold providing a cavity about an end of said mandrel and bag, said bag being configured to provide a face plate and nosepiece;
(c) injecting into said cavity molten synthetic resin of substantially
the same composition as that of said bag to form a face plate with the end of the bag sealingly adhered thereto, said face plate having a discharge opening therein and a nosepiece about said opening aligned with the end of said bag, said face plate being overmolded on said film to produce an integrated structure of essentially uniform composition in which said bag is disposed inwardly of said face plate and there are no distinct layers at the interface; and
(d) removing said face plate, bag and mandrel from said cavity.

26. The method in accordance with claim 25 wherein a pair of synthetic resin bags are mounted on a pair of mandrels and wherein the mandrels are cooperatively configured and cooperate to define a generally circular cross section, said mold cavity and mandrels being configured to provide a partition in said opening and a nosepiece separating the contents of the two bags as the compositions in said bags flow therethrough, and wherein flowable compositions are injected into each of said bags through said nosepiece.

27. The method in accordance with claim 25 wherein a pair of synthetic resin bags are mounted on a pair of mandrels, one of which is annular cross section and the other is of circular cross section and disposed within said annular mandrel, said mold cavity being configured to provide a face plate with a partition in said opening and nosepiece separating the contents of the two bags as the composition in said bags flow therethrough, and wherein flowable compositions are injected into each of said bags through said nosepiece.
